(19) United States
(12) Patent Application Publication
(10) Pub. No.: US 2025/0227657 A1
(43) Pub. Date: Jul. 10, 2025

(54) POSITIONING METHOD AND APPARATUS, STORAGE MEDIUM, AND CHIP

(71) Applicant: Beijing Xiaomi Mobile Software Co., Ltd., Beijing (CN)

(72) Inventor: Xiaolong LI, Beijing (CN)

(21) Appl. No.: 18/880,536

(22) PCT Filed: Jul. 8, 2022
(86) PCT No.: PCT/CN2022/104734

§ 371 Date: Dec. 31, 2024

(51) Int. Cl. H04W 64/00; H04W 74/0833; H04W 76/28

(52) U.S. Cl. CPC H04W 64/003; H04W 74/0833; H04W 76/28

(57) ABSTRACT

A positioning method includes: determining positioning assistance information, and sending the positioning assistance information to a first access network device, the positioning assistance information is used for instructing that the first access network device determines a target positioning resource according to the positioning assistance information, and positions a terminal device according to the target positioning resource.

### CROSS-REFERENCE TO RELATED APPLICATIONS

The present application is a U.S. National Stage of International Application No. PCT/CN2022/104734, filed on Jul. 8, 2022, the contents of all of which are incorporated herein by reference in their entireties for all purposes.

### BACKGROUND

With the development of communication technologies, the 5th generation mobile communication technology (5G) network has been applied to the Internet of Things, industrial control and other fields. Among various business fields, positioning business is one of the more important businesses. The positioning business can acquire location information (such as latitude and longitude coordinates) of a terminal device through a communication network, and realize related applications and services according to the location information of the terminal device, such as location query, active push, item tracking, precise positioning of devices in a factory, and other functions according to the location information.

The 5G network can locate terminal devices through a variety of positioning technologies, such as an uplink positioning technology, a downlink positioning technology, and an uplink and downlink hybrid positioning technology. Among these positioning technologies, an access network device (e.g., a base station) needs to configure related positioning resources, such as a positioning reference signal (PRS) resource, a physical random access channel (PRACH) resource, and a sounding reference signal (SRS) resource.

### SUMMARY

The present disclosure relates to the technical field of communications, and in particular, to a positioning method and apparatus, a storage medium, and a chip.

According to a first aspect of the embodiments of the present disclosure, a positioning method is provided, which is performed by a positioning device. The method includes:
determining positioning assistance information; and
sending the positioning assistance information to a first access network device, where the positioning assistance information is used for instructing the first access network device to determine a target positioning resource according to the positioning assistance information, and position a terminal device according to the target positioning resource.

According to a second aspect of the embodiments of the present disclosure, a positioning method is provided, which is performed by a first access network device. The method includes:
receiving positioning assistance information sent by a positioning device; and
determining a target positioning resource according to the positioning assistance information, where the target positioning resource is used for positioning a terminal device.

According to a third aspect of embodiments of the present disclosure, a positioning apparatus is provided. The positioning apparatus includes:
one or more processors; and
a memory configured to store processor-executable instructions, where
the one or more processors are collectively configured to perform steps of the positioning method provided in the first aspect of the present disclosure.

According to a fourth aspect of embodiments of the present disclosure, a positioning apparatus is provided. The positioning apparatus includes:
one or more processors; and
a memory configured to store processor-executable instructions, where
the one or more processors are collectively configured to perform steps of the positioning method provided in the second aspect of the present disclosure.

According to a fifth aspect of embodiments of the present disclosure, a non-transitory computer-readable storage medium is provided, storing computer program instructions thereon, where when the computer program instructions are collectively executed by one or more processors, steps of the positioning method provided in the first aspect of the present disclosure are implemented.

According to a sixth aspect of embodiments of the present disclosure, a non-transitory computer-readable storage medium is provided, storing computer program instructions thereon, where when the computer program instructions are collectively executed by one or more processors, steps of the positioning method provided in the second aspect of the present disclosure are implemented.

According to a seventh aspect of the embodiments of the present disclosure, a chip is provided. The chip includes one or more processors and an interface, where the one or more processors are collectively configured to read instructions to perform steps of the positioning method provided in the first aspect of the present disclosure.

According to an eighth aspect of the embodiments of the present disclosure, a chip is provided. The chip includes one or more processors and an interface, where the one or more processors are collectively configured to read instructions to perform steps of the positioning method provided in the second aspect of the present disclosure.

It is to be understood that the above general description and the following detailed description are exemplary and illustrative, and not intended to limit the present disclosure.

### BRIEF DESCRIPTION OF DRAWINGS

The accompanying drawings herein are incorporated into the specification and constitute a part of the specification, show embodiments that are consistent with the present disclosure, and are used together with the specification to explain the principles of the present disclosure.

FIG. 1 is a schematic diagram of a communication system illustrated according to an example embodiment.

FIG. 2 is a flowchart of a positioning method illustrated according to an example embodiment.

FIG. 3 is a flowchart of a positioning method illustrated according to an example embodiment.

FIG. 4 is a flowchart of a positioning method illustrated according to an example embodiment.

FIG. 5 is a flowchart of a positioning method illustrated according to an example embodiment.

FIG. 6 is a flowchart of a positioning method illustrated according to an example embodiment.

FIG. 7 is a flowchart of a positioning method illustrated according to an example embodiment.

FIG. 8 is a flowchart of a positioning method illustrated according to an example embodiment.

FIG. 9 is a flowchart of a positioning method illustrated according to an example embodiment.

FIG. 10 is a flowchart of a positioning method illustrated according to an example embodiment.

FIG. 11 is a flowchart of a positioning method illustrated according to an example embodiment.

FIG. 12 is a flowchart of a positioning method illustrated according to an example embodiment.

FIG. 13 is a flowchart of a positioning method illustrated according to an example embodiment.

FIG. 14 is a flowchart of a positioning method illustrated according to an example embodiment.

FIG. 15 is a flowchart of a positioning method illustrated according to an example embodiment.

FIG. 16 is a block diagram of a positioning apparatus illustrated according to an example embodiment.

FIG. 17 is a block diagram of a positioning apparatus illustrated according to an example embodiment.

FIG. 18 is a block diagram of a positioning apparatus illustrated according to an example embodiment.

FIG. 19 is a block diagram of a positioning apparatus illustrated according to an example embodiment.

FIG. 20 is a block diagram of a positioning apparatus illustrated according to an example embodiment.

### DETAILED DESCRIPTION

The examples will be described in detail herein, and the examples are shown in the accompanying drawings. When the following description involves the accompanying drawings, unless otherwise indicated, the same numbers in different accompanying drawings indicate the same or similar elements. The implementations described the following examples are not all the implementations consistent with the present disclosure. On the contrary, these implementations are simply examples of apparatuses and methods consistent with some aspects of the present disclosure, as detailed in the appended claims.

It needs to be noted that all actions to acquire signals, information or data in the present disclosure are carried out in accordance with corresponding data protection regulations and policies of the country where they are located and with the authorization of the owners of the respective apparatuses.

The terms “first”, “second” and the like in the description of the present disclosure are used to distinguish similar objects, but not necessarily understood to describe a specific order or precedence order. In addition, in the description of the reference drawings, the same symbol in different drawings represents the same element, unless the contrary is stated.

In the description of the present disclosure, unless otherwise specified, “a plurality of” means two or more, and other quantifiers are similar thereto; and “at least one of the following”, “one or more”, or similar expressions means any combination of these terms, including a single item or any combination of a plurality of items. For example, one or more of a, b, or c may be represented as a, b, c, a-b, a-c, b-c, or a-b-c, where a, b, and c may be single or multiple. The term “and/or” describes an association relationship of the corresponding objects, indicating three kinds of relationship. For example, A and/or B may be expressed as: A exists alone, A and B exist concurrently, and B exists alone, where A and B may be singular or plural.

Although operations are depicted in the accompanying drawings in a particular order in the embodiments of the present disclosure, this is not construed such that such operations need to be performed in the particular order shown, or in a sequential order, or all illustrated operations need to be performed to achieve desirable results. In certain circumstances, multitasking and parallel processing may be advantageous.

Among related technologies, there is a problem that an access network device cannot reasonably configure positioning resources, resulting in reasonable resource utilization, which affects the positioning effect on a terminal device.

In order to overcome the above problems existing in the related art, the present disclosure provides a positioning method and apparatus, a storage medium, and a chip.

The following first describes an implementation environment of the embodiments of the present disclosure.

The technical solutions of the embodiments of this application may be applied to various communication systems. The communication systems may include one or more of the 4th Generation (4G) communication system, the 5th Generation (5G) communication system, and other future wireless communication systems (such as 6G). The communication system may also include one or more of a public land mobile network (PLMN), a device-to-device (D2D) communication system, a machine to machine (M2M) communication system, an Internet of Things (IoT) communication system, a vehicle-to-everything (V2X) communication system, or other communication systems.

FIG. 1 is a schematic diagram of a communication system illustrated according to an example embodiment. As shown in FIG. 1, the communication system may include a terminal device 101, an access network device 102, and a positioning device 103. The communication system may be used to support the 4th Generation (4G) network access technology, such as a long term evolution (LTE) access technology; or the 5th Generation (5G) network access technology, such as a new radio access technology (New RAT); or other future wireless communication technologies. It needs to be noted that in this communication system, the number of the above terminal device, the access network device and the positioning device may be one or more. The number of the terminal device, the access network device and the positioning device of the communication system shown in FIG. 1 is an illustrative example, which will not be limited in the present disclosure.

The positioning device in FIG. 1 may be used for providing a location management function. For example, the positioning device may include: a location management function (LMF), a location management component (LMC), or a network device deployed with the LMF or the LMC. For example, the positioning device may be a core network device deployed with the LMF, an access network device deployed with the LMC, or an arbitrary network device with a positioning function, which will not be limited in the present disclosure.

The access network device in FIG. 1 may be used for supporting terminal access. For example, the access network device may be an evolutional Node B (eNB or eNodeB) in LTE. The access network device may also be the next Generation Node B (gNB or gNodeB) in a 5G network. The access network device may also be a NG radio access network (NG-RAN) device in the 5G network. The access network device may also be a base station in a future-evolved public land mobile network (PLMN), a broadband network gateway (BNG), an aggregation switch, or a non-3rd Generation Partnership Project (3GPP) access device, etc. In some examples, the access network device in the embodiments of the present disclosure may include various forms of base stations, such as macro base stations, micro base stations (also known as small stations), relay stations, access points, 5G base stations or future base stations, satellites, transmitting and receiving points (TRPs), transmitting points (TPs), mobile switching centers, as well as device-to-device (D2D), machine-to-machine (M2M), Internet of Things (IoT), vehicle-to-everything (V2X) or other devices that function as base stations in communications, which will not be specifically limited in the embodiments of the present disclosure. For the convenience of description, in all embodiments of the present disclosure, apparatuses that provide a wireless communication function for the terminal device are collectively referred to as access network devices or base stations. It needs to be noted that the number of the access network devices may be one or more. For example, the access network devices may include a first access network device, a second access network device, and so on.

The terminal device in FIG. 1 may be an electronic device that provides voice or data connectivity. For example, the terminal device may also be called a user equipment (UE), a subscriber unit, a mobile station, a station, a terminal, etc. For example, the terminal device may include a smart phone, a smart wearable device, a smart speaker, a smart tablet computer, a wireless modem, a wireless local loop (WLL) station, a personal digital assistant (PDA), customer premise equipment (CPE), etc. With the development of wireless communication technologies, devices that may access a communication system, communicate with an access network device of the communication system, or communicate with other objects through the communication system may all be terminal devices in the embodiments of the present disclosure, such as terminals and automobiles in intelligent transportation, household devices in smart homes, power meter reading instruments, voltage monitoring instruments and environmental monitoring instruments in smart grids, video monitoring instruments in intelligent security networks, cash registers, etc. In the embodiments of the present disclosure, the terminal device may communicate with the access network device. The terminal device may also communicate with the positioning device. For example, the terminal device may communicate with the positioning device through the access network device (the access network device plays the role of providing a data forwarding channel), and also communicate with the positioning device by other means. In addition, a plurality of terminal devices may communicate with each other. The terminal device may be statically fixed or mobile, which will not be limited in the present disclosure.

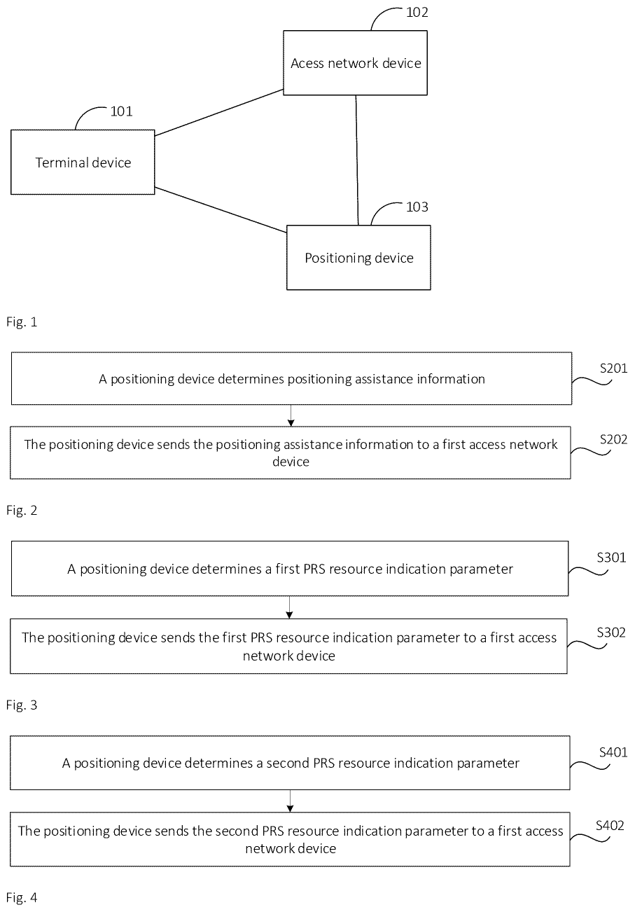

FIG. 2 is a flowchart of a positioning method illustrated according to an example embodiment, which may be performed by the positioning device in the above communication system. As shown in FIG. 2, the method may include the following steps.

In S201, the positioning device determines positioning assistance information.

In S202, the positioning device sends the positioning assistance information to a first access network device.

The positioning assistance information is used for instructing the first access network device to determine a target positioning resource according to the positioning assistance information, and position a terminal device according to the target positioning resource.

For example, the positioning device may send the above positioning assistance information to the first access network device through a first preset message. The first preset message may include one or more of a positioning measurement request message, a positioning information request message, a transmitting and receiving points (TRP) information request message, and a PRS configuration request message.

With the above method, a positioning device determines positioning assistance information, and sends the positioning assistance information to a first access network device. The positioning assistance information is used for instructing the first access network device to determine a target positioning resource according to the positioning assistance information, and position a terminal device according to the target positioning resource. Therefore, a positioning device can send positioning assistance information to an access network device, so as to instruct the access network device to determine a target positioning resource, such that resources can be reasonably utilized and the positioning efficiency of a terminal device can be improved.

The positioning device may determine the positioning assistance information in a variety of ways, for example:

In one embodiment, the above positioning assistance information may include information determined by the positioning device according to a preset positioning assistance parameter that is preconfigured. For example, the preset positioning assistance parameter may be taken as the above positioning assistance information; or, the preset positioning assistance parameter may be taken as part of the above positioning assistance information.

In another embodiment, the above positioning assistance information may include information determined by the positioning device according to the target parameter received from the terminal device or the access network device. For example, the above method for determining the positioning assistance information may include the following steps.

Firstly, the positioning device receives a target parameter sent by the terminal device or a second access network device to the positioning device.

The target parameter may include one or more of a terminal type parameter and a discontinuous reception (DRX) parameter of the terminal device.

In some embodiments, the positioning device may also receive the target parameter sent by the terminal device through uplink positioning data. The uplink positioning data may include uplink LTE positioning protocol (LPP) data.

In some other embodiments, the positioning device may also receive, through a second preset message, a target parameter sent by the second access network device to the positioning device. The second preset message may include one or more of a positioning measurement response message, a positioning information response message, a transmitting and receiving points (TRP) information response message, and a PRS configuration response message. For example, the second preset message may include a positioning information response message, which may be a message sent by the second access network device in response to receiving the positioning information request message sent by the positioning device. The second access network device may be the same or different from the first access network device.

Then, the positioning device determines the positioning assistance information according to the target parameter.

For example, the target parameter may be used as the positioning assistance information; or an appropriate parameter value may be set for the positioning assistance information according to the target parameter.

In another embodiment, the above positioning assistance information may be determined by combining the above two embodiments. That is, the above positioning assistance information may be composed of at least two parts of information, where one part of the information includes information determined by the positioning device according to the preset positioning assistance parameter that is preconfigured, and the other part of the information includes information determined by the positioning device according to the target parameter received from the terminal device or the access network device.

In this way, the positioning device may determine the positioning assistance information through any one of the above methods, so as to instruct the first access network device to determine the target positioning resource according to the positioning assistance information.

In some embodiments of the present disclosure, the above positioning assistance information may include one or more of the following parameters.

Parameter I: a first PRS resource indication parameter, where the first PRS resource indication parameter may be used for instructing the first access network device to determine, according to a DRX parameter of the terminal device, a first physical resource used for sending a PRS.

Parameter II: a second PRS resource indication parameter, where the second PRS resource indication parameter is a parameter which is determined by the positioning device according to the DRX parameter of the terminal device and may be used for instructing the first access network device to determine a second physical resource used for sending the PRS.

Parameter III: a low-power-consumption indication parameter, where the low-power-consumption indication parameter may be used for instructing the first access network device to perform low-power-consumption positioning on the terminal device. For example, the low-power-consumption indication parameter may be used for instructing the first access network device to consider a low-power-consumption requirement for positioning the terminal device.

Parameter IV: a physical random access channel (PRACH) resource indication parameter, where the PRACH resource indication parameter may be used for characterizing a third physical resource used by the terminal device to send a positioning preamble.

Parameter V: a positioning data transmission resource indication parameter, where the positioning data transmission resource indication parameter may be used for instructing the first access network device to determine a fourth physical resource for sending positioning data. The positioning data may include data for positioning sent by the positioning device to the terminal according to a preset positioning protocol. For example, the positioning data may include LPP data.

The following describes each of the above parameters and a positioning method corresponding to this parameter.

FIG. 3 is a flowchart of a positioning method illustrated according to an example embodiment. As shown in FIG. 3, the method may include the following steps.

In S301, a positioning device determines a first PRS resource indication parameter.

In S302, the positioning device sends the first PRS resource indication parameter to a first access network device.

The first PRS resource indication parameter may be used for instructing the first access network device to determine, according to a DRX parameter of the terminal device, a first physical resource used for sending a PRS.

For example, the first PRS resource indication parameter may instruct the first access network device to determine a sending time slot of the PRS as a DRX on duration or not to send the PRS within a DRX off duration, such that the problem of increased power consumption caused by the terminal device actively activating to receive the PRS within the DRX off duration and the problem of positioning failure or low positioning efficiency caused by incapability of some specific terminal devices to receive the PRS within the DRX off duration can be prevented.

In some embodiments, the positioning device may send the first PRS resource indication parameter to the first access network device through one or more of a TRP information request message and a PRS configuration request message.

For example, the positioning device may send the first PRS resource indication parameter to the first access network device through the TRP information request message.

For another example, the positioning device may send the first PRS resource indication parameter to the first access network device through the PRS configuration request message.

For yet another example, the positioning device may send the first PRS resource indication parameter to the first access network device through the TRP information request message and the PRS configuration request message.

In some embodiments, the first PRS resource indication parameter may be one bit or one byte, which may, in the case that the first PRS resource indication parameter is equal to a first preset value, instruct the first access network device to determine, according to the DRX parameter of the terminal device, the first physical resource used for sending the PRS; or on the contrary, in the case that the first PRS resource indication parameter is not equal to the first preset value, instruct the first access network device to directly determine a first physical resource used for sending the PRS, without considering the DRX parameter of the terminal device.

The first PRS resource indication parameter may also be acquired in a variety of ways, for example:

In some embodiments, the first PRS resource indication parameter may be a first preset positioning parameter preconfigured by the positioning device. For example, a value of the first preset positioning parameter may be taken as a value of the first PRS resource indication parameter.

In some other embodiments, the first PRS resource indication parameter may be a parameter determined by the positioning device according to the above target parameter received from the terminal device or the access network device.

For example, a first preset parameter value may be taken as a value of the first PRS resource indication parameter in the case of determining that the terminal device has a low-power-consumption PRS positioning requirement according to the target parameter. The value of the first PRS resource indication parameter is the first preset parameter value, which may be used for characterizing that the positioning device may instruct the first access network device to determine, according to the DRX parameter of the terminal device, a first physical resource used for sending the PRS. The first preset parameter value is the value of the first preset positioning parameter.

In some embodiments, in the case that the target parameter includes the DRX parameter of the terminal device and a DRX function of the terminal device is turned on, the first preset parameter value may be taken as the value of the first PRS resource indication parameter, and the first preset parameter value may be used for characterizing that the terminal device has a low-power-consumption PRS positioning requirement.

In some other embodiments, in the case that the target parameter includes a terminal type parameter of the terminal device and the terminal type parameter characterizes that the terminal device is a low-power-consumption type terminal, the first preset parameter value may be taken as the value of the first PRS resource indication parameter, and the first preset parameter value may be used for characterizing that the terminal device has a low-power-consumption PRS positioning requirement.

In some embodiments, values of the terminal type parameter may include a low-power-consumption type terminal and a common-power-consumption type terminal.

In some other embodiments, the values of the terminal type parameter may also be application types of terminals. For example, the values of the terminal type parameter may include: wearable devices, PADs, IoT terminals, mobile phones, tablet computers, CPEs, vehicle terminals, etc. According to the terminal type parameter and a preset type power consumption correspondence relationship, whether the terminal device is a low-power-consumption type terminal is determined. The preset type power consumption correspondence relationship may include a correspondence relationship indicating whether the preset terminal type parameter is a low-power-consumption type terminal. For example, a terminal device with a terminal type parameter as a wearable device, a PAD, or an IoT terminal may be determined as a low-power-consumption type terminal; and terminal devices with other terminal type parameters may be determined as the common-power-consumption type terminals.

In this way, the positioning device may send the first PRS resource indication parameter to the access network device, so as to instruct the access network device to determine, according to the DRX parameter of the terminal device, the first physical resource used for sending the PRS. In the case that the first access network device is instructed to determine the sending time slot of the PRS as the DRX on duration, or that the PRS is not sent within the DRX off duration, the problem of increased power consumption caused by the terminal device actively activating to receive PRS within the DRX off duration and the problem of positioning failure or low positioning efficiency caused by incapability of some specific terminal devices to receive the PRS within the DRX off duration can be prevented, improving the positioning efficiency for the terminal device is achieved.

FIG. 4 is a flowchart of a positioning method illustrated according to an example embodiment. As shown in FIG. 4, the method may include the following steps.

In S401, a positioning device determines a second PRS resource indication parameter.

In S402, the positioning device sends the second PRS resource indication parameter to a first access network device.

The second PRS resource indication parameter may be a parameter which is determined by the positioning device according to the DRX parameter of the terminal device and used for instructing the first access network device to determine a second physical resource used for sending the PRS.

In some embodiments, the positioning device may send the second PRS resource indication parameter to the first access network device through one or more of a TRP information request message and a PRS configuration request message.

In some embodiments, the second PRS resource indication parameter may be a second preset positioning parameter that is preconfigured by the positioning device. For example, a value of the second preset positioning parameter may be taken as a value of the second PRS resource indication parameter.

In some other embodiments, the second PRS resource indication parameter may be a parameter determined by the positioning device according to the above target parameter received from the terminal device or the access network device.

For example, the positioning device may determine a PRS configuration parameter corresponding to the terminal device according to the target parameter; and take the PRS configuration parameter as the second PRS resource indication parameter. The PRS configuration parameter is used for indicating that the sending time slot of the first access network device to send the PRS is within the DRX on duration of the terminal device.

In some embodiments, this target parameter may include the DRX parameter of the terminal device. For example, the positioning device may receive the DRX parameter corresponding to the terminal device from the terminal device or a second access network device. The DRX parameter may include parameters such as a DRX cycle and the DRX on duration. The positioning device may determine a PRS configuration parameter according to this DRX parameter, e.g., may set an integer multiple of the DRX cycle (e.g., 1×, 2×, or 10×) an integer multiple of the DRX cycle (e.g., 1×, 2×, or 10×), and may set the sending time slot of the PRS within the DRX on duration.

In some other embodiments, the target parameter may include a DRX parameter and a terminal type parameter of the terminal device. In the case of determining that the terminal device is a low-power-consumption type terminal according to the terminal type parameter, the positioning device may determine the PRS configuration parameter according to the DRX parameter, so that the sending time slot of the PRS is within the DRX on duration of the terminal device.

In this way, the PRS configuration parameter is sent to the first access network device as a second PRS resource indication parameter, so that the problem of increased power consumption caused by the wake-up of the terminal device from the DRX off duration to receive the PRS can be prevented.

In some embodiments, the second PRS resource indication parameter may include an on-demand PRS configuration such that an occasion of the terminal device to measure the PRS is within the DRX on duration, or the terminal device does not measure the PRS within the DRX off duration. In this way, the process in the current protocol can be multiplexed to improve the compatibility between network devices.

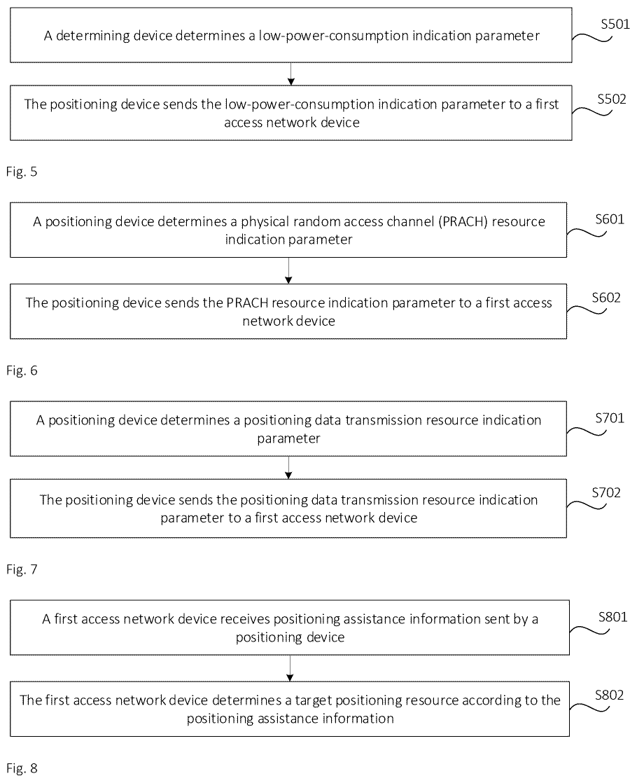

FIG. 5 is a flowchart of a positioning method illustrated according to an example embodiment. As shown in FIG. 5, the method may include the following steps.

In S501, a positioning device determines a low-power-consumption indication parameter.

In S502, the positioning device sends the low-power-consumption indication parameter to a first access network device.

The low-power-consumption indication parameter is used for instructing the first access network device to perform low-power-consumption positioning on the terminal device.

For example, the low-power-consumption indication parameter may be used for instructing the first access network device to consider a low-power-consumption requirement for positioning the terminal device. For example, the first access network device may be instructed to configure a relatively small positioning cycle for fast positioning, saving the power consumption of the terminals is achieved. The first access network device may be instructed to determine the PRS configuration parameter according to the DRX parameter of the terminal device, so that the terminal device receives PRS within the DRX on duration. The first access network device may be instructed to determine an SRS configuration parameter according to the DRX parameter, so that the terminal device sends SRS within the DRX on duration.

In this way, the positioning device may instruct the first access network device to perform low-power-consumption positioning on the terminal device by sending the low-power-consumption indication parameter to the first access network device, reducing the impact of positioning business on the power consumption of the terminal device is achieved.

In some embodiments, the positioning device may send the low-power-consumption indication parameter to the first access network device through one or more of a TRP information request message and a PRS configuration request message.

In some embodiments, the low-power-consumption indication parameter may be determined by the positioning device according to a preconfigured third preset positioning parameter. For example, a value of this third preset positioning parameter may be taken as a value of the low-power-consumption indication parameter.

In some other embodiments, the low-power-consumption indication parameter may be a parameter determined by the positioning device according to the above target parameter received from the terminal device or the access network device.

For example, a second preset parameter value may be taken as a value of the low-power-consumption indication parameter in the case of determining that the terminal device has a low-power-consumption positioning requirement according to the target parameter. The second preset parameter value is the value of this third preset positioning parameter.

Similarly, the target parameter may include one or more of a terminal type parameter and a DRX parameter of the terminal device.

In some embodiments, in the case that the target parameter includes the DRX parameter of the terminal device and a DRX function of the terminal device is turned on, the second preset parameter value may be taken as the value of the low-power-consumption indication parameter, and the second preset parameter value may be used for characterizing that the terminal device has a low-power-consumption positioning requirement.

In some other embodiments, in the case that the target parameter includes a terminal type parameter of the terminal device and the terminal type parameter characterizes that the terminal device is a low-power-consumption type terminal, the second preset parameter value may be taken as the value of the low-power-consumption indication parameter, and the second preset parameter value may be used for characterizing that the terminal device has a low-power-consumption positioning requirement.

FIG. 6 is a flowchart of a positioning method illustrated according to an example embodiment. As shown in FIG. 6, the method may include the following steps.

In S601, a positioning device determines a physical random access channel (PRACH) resource indication parameter; and

In S602, the positioning device sends the PRACH resource indication parameter to a first access network device.

The PRACH resource indication parameter is used for characterizing a third physical resource used by the terminal device to send a positioning preamble.

With the above mode, the positioning device may determine the PRACH resource indication parameter used by the terminal device, and send the PRACH resource indication parameter to the first access network device, so that the first access network device determines the third physical resource used by the terminal device to send the positioning preamble.

In some embodiments, the PRACH resource indication parameter may include one or more of the following: a random access RACH occasion and a random access RACH preamble.

In some embodiments, the PRACH resource indication parameter may be determined by the positioning device according to the PRACH parameter received from the terminal device or the access network device. For example:

Firstly, the positioning device receives the PRACH parameter sent by the terminal device or the second access network device.

The PRACH parameter may be used for characterizing a PRACH resource used by the terminal device to send the positioning preamble.

In some embodiments, the positioning device may receive, through uplink positioning data (e.g., uplink LPP data), the PRACH parameter sent by the terminal device.

In some other embodiments, the positioning device may also receive, through a positioning information response message, the PRACH parameter sent by the second access network device to the positioning device. The positioning information response message is a message sent by the second access network device in response to receiving the positioning information request message sent by the positioning device. The second access network device may be the same or different from the first access network device.

Then, the positioning device determines the PRACH resource indication parameter according to the PRACH parameter.

For example, the PRACH parameter may be taken as the PRACH resource indication parameter; or an appropriate value is set for the PRACH resource indication parameter according to the PRACH parameter.

In some embodiments, the positioning device may send the PRACH resource indication parameter to the first access network device through a positioning measurement request message.

In some embodiments, the positioning device may send the PRACH resource indication parameter to a plurality of access network devices through the positioning measurement request message, so that the plurality of access network devices can measure a random access preamble sent by the terminal device on the PRACH resource. For example, after receiving the PRACH parameter sent by the second access network device, the positioning device may determine the PRACH resource indication parameter according to the PRACH parameter, and send the PRACH resource indication parameter to an adjacent access network device to the second access network device.

The positioning device may determine an adjacent access network device according to location information of the access network device. For example, an access network device with a distance less than or equal to a preset distance from the second access network device may be regarded as the above adjacent access network device.

The positioning device may also determine an adjacent access network device to the second access network device according to an adjacent area parameter sent by the second access network device.

FIG. 7 is a flowchart of a positioning method illustrated according to an example embodiment. As shown in FIG. 7, the method may include the following steps.

In S701, a positioning device determines a positioning data transmission resource indication parameter.

In some embodiments, the positioning data transmission resource indication parameter may be a fourth preset positioning parameter preconfigured by the positioning device. For example, a value of this fourth preset positioning parameter may be taken as a value of the positioning data transmission resource indication parameter.

In some other embodiments, the positioning device may acquire a sending parameter of the positioning data for positioning the terminal device, where the sending parameter may include one or more of a data size and a sending cycle of the positioning data; and determine the positioning data transmission resource indication parameter according to the sending parameter. The positioning data may include downlink positioning data (e.g., downlink LPP data).

In S702, the positioning device sends the positioning data transmission resource indication parameter to a first access network device.

The positioning data transmission resource indication parameter is used for instructing the first access network device to determine a fourth physical resource for sending positioning data.

For example, the fourth physical resource may include one or more of a downlink configured grant (CG) resource and a downlink configured grant-based small data transmission (CG-SDT) resource.

With the above mode, the positioning device may determine the positioning data transmission resource indication parameter, and send the positioning data transmission resource indication parameter to the first access network device, so that the first access network device determines the fourth physical resource used for sending the positioning data to the terminal device.

In some embodiments, the positioning device may send the positioning data transmission resource indication parameter to the first access network device through the positioning information request message.

FIG. 8 is a flowchart of a positioning method illustrated according to an example embodiment, which may be performed by the access network device (e.g., the first access network device) in the above communication system. As shown in FIG. 8, the method may include the following steps.

In S801, the first access network device receives positioning assistance information sent by a positioning device.

In S802, the first access network device determines a target positioning resource according to the positioning assistance information.

The target positioning resource may be used for positioning a terminal device.

For example, the first access network device may receive, through a first preset message, the above positioning assistance information sent by the positioning device, where the first preset message may include one or more of a positioning measurement request message, a positioning information request message, a transmitting and receiving points (TRP) information request message, and a PRS configuration request message.

With the above method, a first access network device receives positioning assistance information sent by a positioning device; and determines a target positioning resource according to the positioning assistance information. The target positioning resource is used for positioning a terminal device. In this way, a first access network device may determine a target positioning resource according to positioning assistance information sent by a positioning device, such that resources can be reasonably utilized and the positioning efficiency of a terminal device can be improved.

In some embodiments of the present disclosure, the above positioning assistance information is information determined by the positioning device according to the target parameter. The target parameter is a parameter sent by the terminal device or a second access network device to the positioning device, and the target parameter may include one or more of a terminal type parameter and a discontinuous reception (DRX) parameter of the terminal device.

The second access network device may be the same or different from the first access network device.

In some embodiments, the access network device (e.g., the first access network device or the second access network device) may send the above target parameter to the positioning device, and the target parameter may instruct the positioning device to determine the positioning assistance information according to the target parameter.

For example, the access network device may send the above target parameter to the positioning device through a second preset message. The second preset message may include one or more of a positioning measurement response message, a positioning information response message, a transmitting and receiving points (TRP) information response message, and a PRS configuration response message. For example, the second preset message may include a positioning information response message, which may be a message sent by the access network device in response to receiving the positioning information request message sent by the positioning device.

It needs to be noted that a specific manner in which the positioning device determines the positioning assistance information may refer to the specific description of the aforementioned embodiments of the present disclosure, and will not be repeated here.

In some embodiments of the present disclosure, the above positioning assistance information may include one or more of the following parameters.

Parameter I: a first PRS resource indication parameter, where the first PRS resource indication parameter may be used for instructing the first access network device to determine, according to a DRX parameter of the terminal device, a first physical resource used for sending a PRS;

Parameter II: a second PRS resource indication parameter, where the second PRS resource indication parameter is a parameter which is determined by the positioning device according to the DRX parameter of the terminal device and may be used for instructing the first access network device to determine a second physical resource used for sending the PRS.

Parameter III: a low-power-consumption indication parameter, where the low-power-consumption indication parameter may be used for instructing the first access network device to perform low-power-consumption positioning on the terminal device. For example, the low-power-consumption indication parameter may be used for instructing the first access network device to consider a low-power-consumption requirement for positioning the terminal device.

Parameter IV: a physical random access channel (PRACH) resource indication parameter, where the PRACH resource indication parameter may be used for characterizing a third physical resource used by the terminal device to send a positioning preamble.

Parameter V: a positioning data transmission resource indication parameter, where the positioning data transmission resource indication parameter may be used for instructing the first access network device to determine a fourth physical resource for sending positioning data. The positioning data may include data for positioning sent by the positioning device to the terminal according to a preset positioning protocol. For example, the positioning data may include LPP data.

The following describes each of the above parameters and a positioning method corresponding to this parameter.

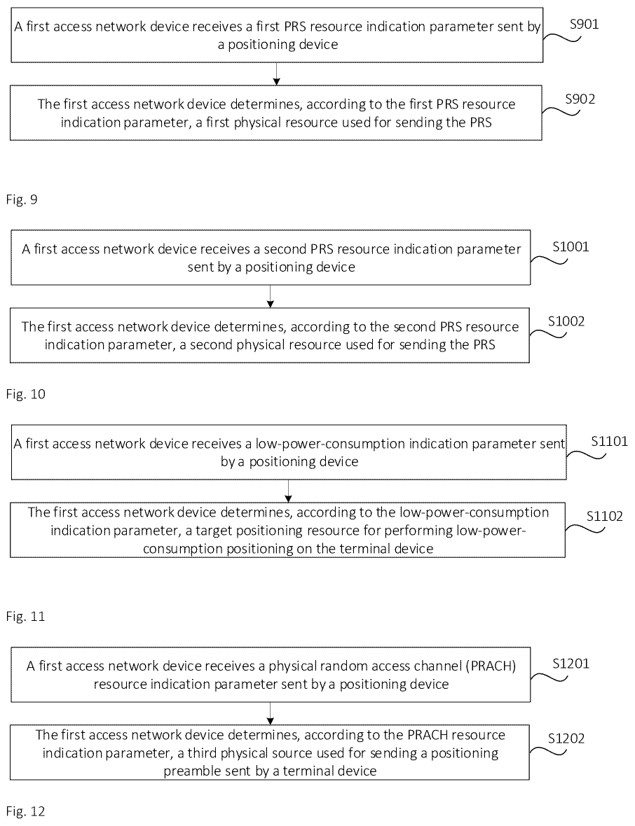

FIG. 9 is a flowchart of a positioning method illustrated according to an example embodiment. As shown in FIG. 9, the method may include the following steps.

In S901, a first access network device receives a first PRS resource indication parameter sent by a positioning device.

In S902, the first access network device determines, according to the first PRS resource indication parameter, a first physical resource used for sending the PRS.

In some embodiments, the first access network device may acquire the discontinuous reception (DRX) parameter of the terminal device in response to receiving the first PRS resource indication parameter, and determine, according to the DRX parameter, a first physical resource used for sending the PRS. A sending time slot corresponding to the first physical resource is within a DRX on duration of the terminal device.

For example, the DRX parameter may include parameters such as the DRX cycle and the DRX on duration, and the first access network device may determine a PRS configuration parameter according to the DRX parameter. For example, an integer multiple (e.g., 1×, 2×, or 10×) of the DRX cycle may be used as a PRS transmission cycle, and a sending time slot of PRS may be set within the DRX on duration. The first physical resource used for sending the PRS may be determined according to the PRS configuration parameter, and the terminal device may be notified to receive the PRS according to the PRS configuration parameter. In this way, the time of the terminal device to receive or measure the PRS may be within the DRX on duration, or the terminal device may not receive or measure the PRS within the DRX off duration.

In this way, the first access network device determines the sending time slot of PRS as the DRX on duration according to the received first PRS resource indication parameter, or does not send the PRS within the DRX off duration, such that the problem of increased power consumption caused by the terminal device actively activating to receive the PRS within the DRX off duration and the problem of positioning failure or low positioning efficiency caused by incapability of some specific terminal devices to receive the PRS within the DRX off duration can be prevented, improving the positioning efficiency for the terminal device is achieved.

In some embodiments, the first access network device may receive the first PRS resource indication parameter sent by the positioning device through one or more of the TRP information request message and the PRS configuration request message.

FIG. 10 is a flowchart of a positioning method illustrated according to an example embodiment. As shown in FIG. 10, the method may include the following steps.

In S1001, a first access network device receives a second PRS resource indication parameter sent by a positioning device.

In S1002, the first access network device determines, according to the second PRS resource indication parameter, a second physical resource used for sending the PRS.

The second PRS resource indication parameter may be a parameter which is determined by the positioning device according to the DRX parameter of the terminal device and used for instructing the first access network device to determine a second physical resource used for sending the PRS.

For example, in the case of receiving the second PRS resource indication parameter, the first access network device may determine a PRS configuration parameter corresponding to the terminal device according to the second PRS resource indication parameter, and determine, according to the PRS configuration parameter, a second physical resource used for sending the PRS. The PRS configuration parameter is used for instructing that a sending time slot of the first access network device to send the PRS is within a DRX on duration of the terminal device.

It needs to be noted that a specific manner in which the positioning device determines the second PRS resource indication parameter may refer to the specific description of the aforementioned embodiments of the present disclosure, and will not be repeated here.

In this way, the first access network device determines the sending time slot of PRS as the DRX on duration according to the received second PRS resource indication parameter, or does not send the PRS within the DRX off duration, such that the problem of increased power consumption caused by the terminal device actively activating to receive the PRS within the DRX off duration and the problem of positioning failure or low positioning efficiency caused by incapability of some specific terminal devices to receive the PRS within the DRX off duration can be prevented, improving the positioning efficiency for the terminal device is achieved.

In some embodiments, the first access network device may receive the second PRS resource indication parameter sent by the positioning device through one or more of a TRP information request message and a PRS configuration request message.

In some embodiments, the second PRS resource indication parameter may include an on-demand PRS configuration such that an occasion of the terminal device to measure the PRS is within the DRX on duration, or the terminal device does not measure the PRS within the DRX off duration. In this way, the process in the current protocol can be multiplexed to improve the compatibility between network devices.

FIG. 11 is a flowchart of a positioning method illustrated according to an example embodiment. As shown in FIG. 11, the method may include the following steps.

In S1101, a first access network device receives a low-power-consumption indication parameter sent by a positioning device.

In S1102, the first access network device determines, according to the low-power-consumption indication parameter, a target positioning resource for performing low-power-consumption positioning on the terminal device.

The low-power-consumption indication parameter is used for instructing the first access network device to perform low-power-consumption positioning on the terminal device. For example, the low-power-consumption indication parameter may be used for instructing the first access network device to consider a low-power-consumption requirement for positioning the terminal device.

In some embodiments, in the case of receiving the low-power-consumption indication parameter, the first access network device may determine the target positioning resource for performing low-power-consumption positioning on the terminal device.

For example, the first access network device may configure a relatively small positioning cycle (e.g., a preset positioning cycle) for the terminal device to facilitate rapid positioning, saving the power consumption of the terminal device is achieved.

For another example, the first access network device may determine the PRS configuration parameter according to the DRX parameter of the terminal device, so that the terminal device receives the PRS within the DRX on duration, or does not receive the PRS within the DRX off duration.

For another example, the first access network device may determine a SRS configuration parameter according to the DRX parameter, so that the terminal device sends the SRS within the DRX on duration, or does not send the SRS within the DRX off duration.

In this way, the impact of positioning business on the power consumption of the terminal device can be reduced.

In some embodiments, the first access network device may receive, through one or more of a TRP information request message and a PRS configuration request message, the low-power-consumption indication parameter sent by the positioning device.

FIG. 12 is a flowchart of a positioning method illustrated according to an example embodiment. As shown in FIG. 12, the method may include the following steps.

In S1201, a first access network device receives a physical random access channel (PRACH) resource indication parameter sent by a positioning device.

In S1202, the first access network device determines, according to the PRACH resource indication parameter, a third physical resource used by a terminal device to send a positioning preamble.

The third physical resource is used for receiving the positioning preamble sent by the terminal device, so that the terminal device is positioned.

With the above method, the first access network device may determine, according to the received PRACH resource indication parameter, the third physical resource used by the terminal device to send the positioning preamble.

In some embodiments, the PRACH resource indication parameter includes one or more of a random access RACH occasion and a random access RACH preamble.

In some embodiments, the first access network device may receive, through a positioning measurement request message, the PRACH resource indication parameter sent by the positioning device.

In some embodiments, the access network device (e.g., the first access network device or the second access network device) may send a PRACH parameter to the positioning device, where the PRACH parameter is used for characterizing the PRACH resource used by the terminal device to send the positioning preamble.

For example, in the case of configuring the PRACH resource for the terminal device, the access network device may send the above PRACH parameter to the positioning device through a positioning information response message.

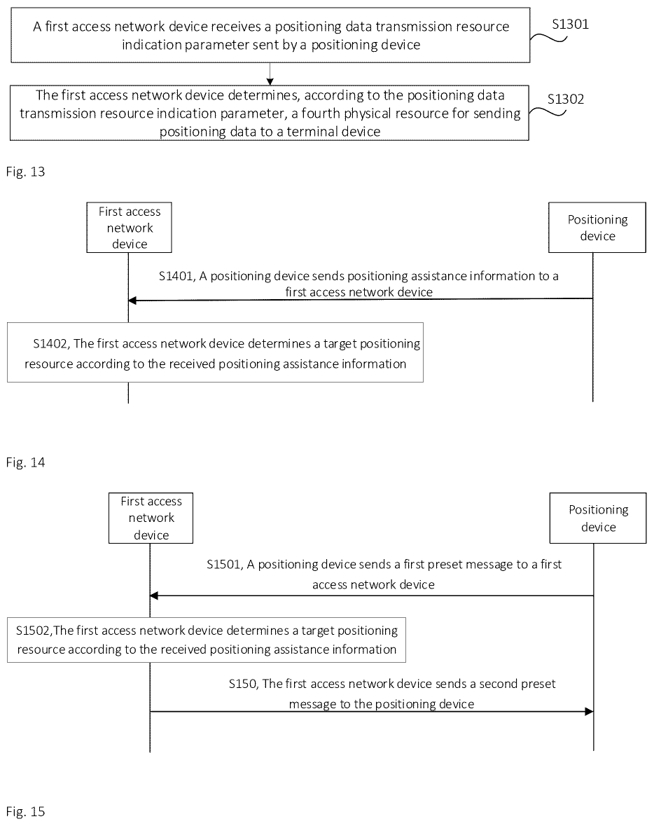

FIG. 13 is a flowchart of a positioning method illustrated according to an example embodiment. As shown in FIG. 13, the method may include the following steps.

In S1301, a first access network device receives a positioning data transmission resource indication parameter sent by a positioning device.

In some embodiments, the above positioning data transmission resource indication parameter may include one or more of a data size and a sending cycle of the positioning data. For example, the positioning data may include downlink positioning data (e.g., downlink LPP data).

In some embodiments, the first access network device may receive, through a positioning information request message, the positioning assistance information sent by the positioning device.

In S1302, the first access network device determines, according to the positioning data transmission resource indication parameter, a fourth physical resource for sending positioning data to the terminal device.

In some embodiments, the fourth physical resource may include one or more of a downlink Configured grant (CG) resource and a downlink Configured Grant-based Small Data Transmission (CG-SDT) resource.

With the above mode, the first access network device reasonably determines, according to the positioning data transmission resource indication parameter, the fourth physical resource used for sending the positioning data to the terminal device, preventing insufficient resources or waste of resources is achieved.

FIG. 14 is a flowchart of a positioning method illustrated according to an example embodiment. As shown in FIG. 14, the method may include the following steps.

In S1401, a positioning device sends positioning assistance information to a first access network device.

In S1402, the first access network device determines a target positioning resource according to the received positioning assistance information.

The target positioning resource may be used for positioning a terminal device.

It needs to be noted that a specific implementation manner in which the positioning device sends the positioning assistance information and the first access network device determines the target positioning source may refer to the specific content of the aforementioned embodiments, and will not be repeated here.

With the above method, a first access network device receives positioning assistance information sent by a positioning device; and determines a target positioning resource according to the positioning assistance information. The target positioning resource may be used for positioning a terminal device. In this way, a first access network device may determine a target positioning resource according to positioning assistance information sent by a positioning device, such that resources can be reasonably utilized and the positioning efficiency of a terminal device can be improved.

FIG. 15 is a flowchart of a positioning method illustrated according to an example embodiment. As shown in FIG. 15, the method may include the following steps.

In S1501, a positioning device sends a first preset message to a first access network device.

The first preset message may include positioning assistance information.

In S1502, the first access network device determines a target positioning resource according to the received positioning assistance information.

The target positioning resource may be used for positioning a terminal device.

In S1503, the first access network device sends a second preset message to the positioning device.

The second preset message may be a response message to the first preset message.

In some embodiments, the first preset message may include a positioning measurement request message, and the second preset message may include a positioning measurement response message.

For example, the positioning device (e.g., LMF) may include a RACH resource configuration indication parameter in the positioning measurement response message. The first access network device (e.g., gNB) may determine a RACH resource according to the RACH resource configuration indication parameter, perform positioning measurement on the terminal device, and send a positioning measurement result to the positioning device through the positioning measurement response message.

In some embodiments, prior to sending the positioning measurement request message, the positioning device may also acquire a PRACH parameter from the terminal device or the second access network device (e.g., an access network device where a current service cell of the terminal device is located), and determine the above RACH resource configuration indication parameter according to the PRACH parameter.

For example, the positioning device may send a positioning information request message to the second access network device. In the case that the second access network device configures the PRACH resource for the terminal device for positioning, the second access network device may send the PRACH parameter to the positioning device through the positioning information response message.

In some embodiments, the first preset message may include a positioning information request message, and the second preset message may include a positioning information response message.

For example, the positioning device may send a positioning data transmission resource indication parameter through a positioning information request message, and the positioning data transmission resource indication parameter may include one or more of a data size and a sending cycle of the positioning data sent by the positioning device. The first access network device may determine, according to the data size and/or the sending cycle, a fourth physical resource for sending the positioning data. For example, the fourth physical resource may include one or more of a downlink CG resource, a downlink CG-SDT resource, and a downlink DG resource.

In some embodiments, in the case of sending the positioning information response message, the access network device (e.g., a first access network device, a second access network device, or an access network device corresponding to the current service message of the terminal device) may include a target parameter in the positioning information response message in response to a request of the positioning device or according to the configuration of the access network device. The target parameter may include one or more of a DRX parameter and a terminal type parameter corresponding to the terminal device. The positioning device may determine the above positioning assistance information according to the target parameter.

In some embodiments of the present disclosure, the first preset message may include a TRP information request message, and the second preset message may include a TRP information response message.

For example, the positioning device may include a first PRS resource indication parameter in the sent TRP information request message; and the first access network device may determine, according to the first PRS resource indication parameter, a first physical resource used for sending the PRS.

For another example, the positioning device may include a second PRS resource indication parameter in the sent TRP information request message; and the first access network device may determine, according to the second PRS resource indication parameter, a second physical resource used for sending the PRS.

For yet another example, the positioning device may include a low-power-consumption indication parameter in the sent TRP information request message, and the first access network device determines, according to the low-power-consumption indication parameter, a target positioning resource for performing low-power-consumption positioning on the terminal device.

In some embodiments, the first preset message may include a PRS configuration request message, and the second preset message may include a PRS configuration response message.

For example, the positioning device may include a first PRS resource indication parameter in the sent PRS configuration request message; and the first access network device may determine, according to the first PRS resource indication parameter, a first physical resource used for sending the PRS.

For another example, the positioning device may include a second PRS resource indication parameter in the sent PRS configuration request message; and the first access network device may determine, according to the second PRS resource indication parameter, a second physical resource used for sending the PRS.

For yet another example, the positioning device may include a low-power-consumption indication parameter in the sent PRS configuration request message; and the first access network device may determine, according to the low-power-consumption indication parameter, a target positioning resource for performing low-power-consumption positioning on the terminal device.

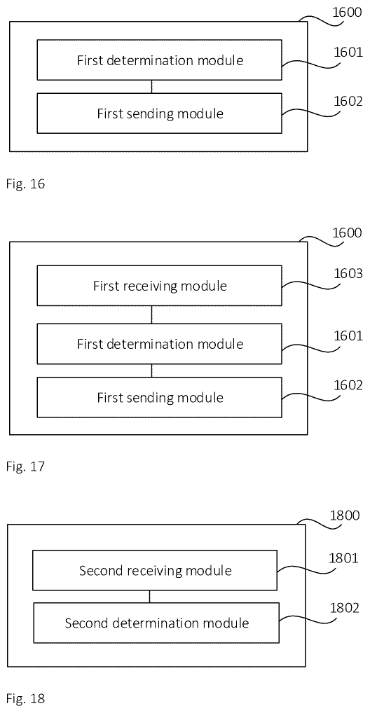

FIG. 16 is a block diagram of a positioning apparatus 1600 illustrated according to an example embodiment, which may be arranged on a positioning device. As shown in FIG. 16, the apparatus 1600 may include:
a first determination module 1601, configured to determine positioning assistance information; and
a first sending module 1602, configured to send the positioning assistance information to a first access network device, where the positioning assistance information is used for instructing the first access network device to determine a target positioning resource according to the positioning assistance information, and position a terminal device according to the target positioning resource.

In some embodiments, the positioning assistance information includes one or more of the following:
a first PRS resource indication parameter, where the first PRS resource indication parameter is used for instructing the first access network device to determine, according to a DRX parameter of the terminal device, a first physical resource used for sending a PRS;
a second PRS resource indication parameter, where the second PRS resource indication parameter is a parameter which is determined by the positioning device according to the DRX parameter of the terminal device and used for instructing the first access network device to determine a second physical resource used for sending a PRS; and
a low-power-consumption indication parameters, where the low-power-consumption indication parameter is used for instructing the first access network device to perform low-power-consumption positioning on the terminal device.

FIG. 17 is a block diagram of a positioning apparatus illustrated according to an example embodiment. As shown in FIG. 17, the apparatus 1600 may also include:
a first receiving module 1603, configured to receive a target parameter sent by the terminal device or a second access network device to the positioning device, where the target parameter includes one or more of a terminal type parameter and a discontinuous reception (DRX) parameter of the terminal device; and
the first determination module 1601, configured to determine the positioning assistance information according to the target parameter.

In some embodiments, in the case that the positioning assistance information includes the first PRS resource indication parameter, the first determination module 1601 is configured to take the first preset parameter value as a value of the first PRS resource indication parameter in the case of determining that the terminal device has a low-power-consumption PRS positioning requirement according to the target parameter.

In some embodiments, in the case that the positioning assistance information includes the second PRS resource indication parameter, the first determination module 1601 is configured to determine a PRS configuration parameter corresponding to the terminal device according to the target parameter, where the PRS configuration parameter is used for instructing that a sending time slot of the first access network device to send the PRS is within a DRX on duration of the terminal device; and take the PRS configuration parameter as the second PRS resource indication parameter.

In some embodiments, in the case that the positioning assistance information includes the low-power-consumption indication parameter, the first determination module 1601 is configured to take a second preset parameter value as a value of the low-power-consumption indication parameter in the case of determining that the terminal device has a low-power-consumption positioning requirement according to the target parameter.

In some embodiments, the first sending module 1602 is configured to send the positioning assistance information to the first access network device through one or more of a TRP information request message and a PRS configuration request message.

In some embodiments, the positioning assistance information includes a physical random access channel (PRACH) resource indication parameter, where the PRACH resource indication parameter is used for characterizing a third physical resource used by the terminal device to send a positioning preamble.

In some embodiments, the first receiving module 1603 is configured to receive a PRACH parameter sent by the terminal device or the second access network device, where the PRACH parameter is used for characterizing the PRACH resource used by the terminal device to send the positioning preamble; and
the first determination module 1601 is configured to determine the PRACH resource indication parameter according to the PRACH parameter.

In some embodiments, the PRACH resource indication parameter includes one or more of the following:
a random access RACH occasion; and
a random access RACH permeable.

In some embodiments, the first sending module 1602 is configured to send the PRACH resource indication parameter to the first access network device through a positioning measurement request message.

In some embodiments, the positioning assistance information includes a positioning data transmission resource indication parameter; and the positioning data transmission resource indication parameter is used for instructing the first access network device to determine a fourth physical resource for sending positioning data.

In some embodiments, in the case that the positioning assistance information includes the positioning data transmission resource indication parameter, the first determination module 1601 is configured to acquire a sending parameter of positioning data for positioning the terminal device, where the sending parameter includes one or more of a data size and a sending cycle of the positioning data; and determine the positioning data transmission resource indication parameter according to the sending parameter.

In some embodiments, the first sending module 1602 is configured to send the positioning data transmission resource indication parameter to the first access network device through the positioning information request message.

FIG. 18 is a block diagram of a positioning apparatus 1800 illustrated according to an example embodiment, which may be arranged on a first access network device. As shown in FIG. 18, the apparatus 1800 may include:
a second receiving module 1801, configured to receive positioning assistance information sent by a positioning device; and
a second determination module 1802, configured to determine a target positioning resource according to the positioning assistance information, where the target positioning resource is used for positioning a terminal device.

In some embodiments, the positioning assistance information includes one or more of the following:
a first PRS resource indication parameter, where the first PRS resource indication parameter is used for instructing the first access network device to determine, according to a DRX parameter of the terminal device, a first physical resource used for sending a PRS;
a second PRS resource indication parameter, where the second PRS resource indication parameter is a parameter which is determined by the positioning device according to the DRX parameter of the terminal device and used for instructing the first access network device to determine a second physical resource used for sending a PRS; and
a low-power-consumption indication parameter, where the low-power-consumption indication parameter is used for instructing the first access network device to perform low-power-consumption positioning on the terminal device.

In some embodiments, the positioning assistance information is information determined by the positioning device according to the target parameter. The target parameter is a parameter sent by the terminal device or a second access network device to the positioning device, and the target parameter includes one or more of a terminal type parameter and the discontinuous reception (DRX) parameter of the terminal device.

In some embodiments, the second determination module 1802 is configured to acquire a discontinuous reception (DRX) parameter of the terminal device in the case that the positioning assistance information includes the first PRS resource indication parameter, and determine, according to the DRX parameter, a first physical resource used for sending the PRS. A sending time slot corresponding to the first physical resource is within a DRX on duration of the terminal device.

In some embodiments, the second determination module 1802 is configured to determine a PRS configuration parameter corresponding to the terminal device according to the second PRS resource indication parameter in the case that the positioning assistance information includes the second PRS resource indication parameter, where the PRS configuration parameter is used for instructing that a sending time slot of the first access network device to send the PRS is within the DRX on duration of the terminal device; and determine, according to the PRS configuration parameter, a second physical source used for sending the PRS.

In some embodiments, the second determination module 1802 is configured to determine a target positioning resource for performing low-power-consumption positioning on the terminal device in the case that the positioning assistance information includes the low-power-consumption indication parameter.

FIG. 19 is a block diagram of a positioning apparatus illustrated according to an example embodiment. As shown in FIG. 19, the apparatus 1800 may also include:
a second sending module 1803, configured to send a target parameter to the positioning device, where the target parameter includes one or more of a terminal type parameter and a discontinuous reception (DRX) parameter of the terminal device.

In some embodiments, the second receiving module 1801 is configured to receive, through one or more of a TRP information request message and a PRS configuration request message, the positioning assistance information sent by a positioning device.

In some embodiments, the positioning assistance information includes a PRACH resource indication parameter; the second determination module 1802 is configured to determine, according to the PRACH resource indication parameter, a third physical resource used by the terminal device to send a positioning preamble; and the third physical resource is used for receiving the positioning preamble sent by the terminal device, so that the terminal device is positioned.

In some embodiments, the PRACH resource indication parameter includes one or more of the following:
a random access RACH occasion; and
a random access RACH permeable.

In some embodiments, the second sending module 1803 is configured to send a PRACH parameter to the positioning device, where the PRACH parameter is used for characterizing a PRACH resource used by the terminal device to send the positioning preamble.

In some embodiments, the second receiving module 1801 is configured to receive, through a positioning measurement request message, the PRACH resource indication parameter sent by the positioning device.

In some embodiments, the positioning assistance information includes a positioning data transmission resource indication parameter. The second determination module 1802 is configured to determine, according to the positioning data transmission resource indication parameter, a fourth physical resource for sending positioning data.

In some embodiments, the positioning data transmission resource indication parameter includes one or more of a data size and a sending cycle of the positioning data.

In some embodiments, the second receiving module 1801 is configured to receive, through a positioning information request message, the positioning assistance information sent by the positioning device.

With respect to the apparatus in the above embodiments, the specific manner in which module performs the operation has been described in detail in the embodiments of the method, and a detailed description will not be given here.

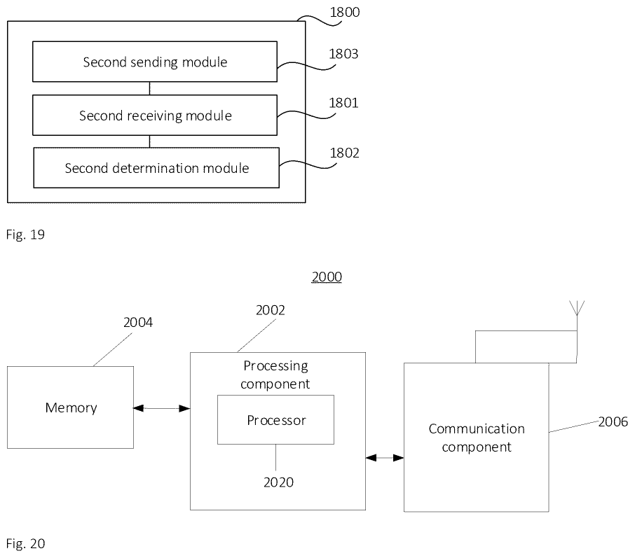

FIG. 20 is a block diagram of a positioning apparatus illustrated according to an example embodiment. The positioning device 2000 may be a positioning device in the communication system shown in FIG. 1, or an access network device (e.g., a first access network device) in the communication system. Referring to FIG. 20, the apparatus 2000 may include one or more of the following components: a processing component 2002, a memory 2004, and a communication component 2006.

The processing component 2002 may be used for controlling overall operations of the apparatus 2000, such as operations associated with display, telephone calls, data communications, camera operations, and recording operations. The processing component 2002 may include one or more processors 2020 to execute instructions to complete all or part of the steps of the positioning method described above. In addition, the processing component 2002 may include one or more modules to facilitate the interaction between the processing component 2002 and other components. For instance, the processing component 2002 may include a multimedia module to facilitate the interaction between the multimedia component and the processing component 2002.

The memory 2004 is configured to store various types of data to support operations on the apparatus 2000. Examples of such data include instructions for any applications or methods operated on the apparatus 2000, contact data, phonebook data, messages, pictures, videos, etc. The memory 2004 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The communication component 2006 is configured to facilitate communication, wired or wirelessly, between the apparatus 2000 and other devices. The apparatus 2000 may access a wireless network based on a communication standard, such as Wi-Fi, 2G, 3G, 4G, 5G, 6G, NB-IoT, eMTC, etc., or a combination thereof. In an example, the communication component 2006 receives a broadcast signal or broadcast associated information from an external broadcast management system via a broadcast channel. In an example, the communication component 2006 also includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an example, the apparatus 2000 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above positioning methods.

In addition to being an independent electronic device, the apparatus 2000 may also be part of an independent electronic device. For example, in an embodiment, the electronic device may be an integrated circuit (IC) or a chip. The integrated circuit may be an IC or a set of a plurality of ICs. The chip may include, but is not limited to, the following types: a graphics processing unit (GPU), a central processing unit (CPU), a field programmable gate array (FPGA), a digital signal processor (DSP), an application specific integrated circuit (ASIC), a system on chip (SOC), etc. The above integrated circuit or chip may be used to execute executable instructions (or codes), so as to implement the above positioning methods. The executable instructions may be stored in the integrated circuit or chip, or derived from other apparatuses or devices. For example, the integrated circuit or chip includes a processor, a memory, and an interface for communication with other apparatuses. The executable instructions may be stored in the processor. When the executable instructions are executed by the processor, the above positioning methods are implemented. Alternatively, the integrated circuit or chip may receive the executable instructions through the interface, and transmit the instructions to the processor for execution, so as to implement the above positioning methods.

In an example, the present disclosure also provides a computer-readable storage medium storing computer program instructions thereon. When the program instructions are executed by a processor, the steps of the positioning methods provided by the present disclosure are implemented. For example, the computer-readable storage medium may be a non-temporary computer-readable storage medium that includes instructions. For example, the computer-readable storage medium may be the above memory 2004 including instructions, which may be executed by a processor 2020 of the apparatus 2000 to complete the above positioning methods. For example, the non-temporary, computer-readable storage medium may be an ROM, a random access memory (RAM), a compact disc read-only memory (CD-ROM), a magnetic tape, a floppy disk, an optical data storage device, etc.

In another example, a computer program product is also provided. The computer program product includes a computer program capable of being executed by a programmable apparatus. The computer program has a code portion for executing the positioning method described above when executed by the programmable apparatus.

Other embodiments of the present disclosure will be readily conceivable to those skilled in the art from consideration of the specification and practice of the present disclosure. The present application is intended to cover any variations, uses, or adaptations of the present disclosure, and these variations, uses, or adaptations follow the general principles of the present disclosure and include common general knowledge or customarily used technical means which are not disclosed herein. The specification and embodiments are to be considered as exemplary, and the true scope and spirit of the present disclosure are indicated by the following claims.

It will be appreciated that the present disclosure is not limited to the exact construction that has been described above and illustrated in the accompanying drawings, and that various modifications and changes can be made without departing from the scope thereof. The scope of the present disclosure is limited by the appended claims.

1. A positioning method, performed by a positioning device, the positioning method comprising:
determining positioning assistance information; and
sending the positioning assistance information to a first access network device, wherein the positioning assistance information is used for instructing the first access network device to determine a target positioning resource according to the positioning assistance information, and position a terminal device according to the target positioning resource.

2. The positioning method according to claim 1, wherein the positioning assistance information comprises one or more of the following:
a first positioning reference signal (PRS) resource indication parameter, wherein the first PRS resource indication parameter is used for instructing the first access network device to determine, according to a discontinuous reception (DRX) parameter of the terminal device, a first physical resource used for sending a PRS;
a second PRS resource indication parameter, wherein the second PRS resource indication parameter is a parameter which is determined by the positioning device according to a discontinuous reception (DRX) parameter of the terminal device and used for instructing the first access network device to determine a second physical resource used for sending a PRS; and
a low-power-consumption indication parameter, wherein the low-power-consumption indication parameter is used for instructing the first access network device to perform low-power-consumption positioning on the terminal device.

3. The positioning method according to claim 2, wherein the determining positioning assistance information comprises:
receiving a target parameter sent by the terminal device or a second access network device to the positioning device, wherein the target parameter comprises one or more of a terminal type parameter and the discontinuous reception (DRX) parameter of the terminal device; and
determining the positioning assistance information according to the target parameter.

4. The positioning method according to claim 3, wherein the determining the positioning assistance information according to the target parameter comprises at least one of the following:
taking a first preset parameter value as a value of the first PRS resource indication parameter in response to determining that the terminal device has a low-power-consumption PRS positioning requirement according to the target parameter in a case that the positioning assistance information comprises the first PRS resource indication parameter;
determining a PRS configuration parameter corresponding to the terminal device according to the target parameter, taking the PRS configuration parameter as the second PRS resource indication parameter, in a case that the positioning assistance information comprises the second PRS resource indication parameter, wherein the PRS configuration parameter is used for instructing that a sending time slot of the first access network device to send the PRS is within a DRX on duration of the terminal device; or
taking a second preset parameter value as a value of the low-power-consumption indication parameter in response to determining that the terminal device has a low-power-consumption positioning requirement according to the target parameter in a case that the positioning assistance information comprises the low-power-consumption indication parameter.

5-6. (canceled)

7. The positioning method according to claim 2, wherein the sending the positioning assistance information to a first access network device comprises:
sending the positioning assistance information to the first access network device through one or more of a transmitting and receiving point (TRP) information request message and a PRS configuration request message.

8. The positioning method according to claim 1, wherein the positioning assistance information comprises a physical random access channel (PRACH) resource indication parameter; and the PRACH resource indication parameter is used for characterizing a third physical resource used by the terminal device to send a positioning preamble.

9. The positioning method according to claim 8, wherein the determining positioning assistance information comprises:
receiving a PRACH parameter sent by the terminal device or a second access network device, wherein the PRACH parameter is used for characterizing a PRACH resource used by the terminal device to send the positioning preamble, wherein the PRACH resource indication parameter comprises one or more of a random access RACH occasion and a random access RACH permeable; and
determining the PRACH resource indication parameter according to the PRACH parameter;
wherein the sending the positioning assistance information to a first access network device comprises:
sending the PRACH resource indication parameter to the first access network device through a positioning measurement request message.

10-11. (canceled)

12. The positioning method according to claim 1, wherein the positioning assistance information comprises a positioning data transmission resource indication parameter; and the positioning data transmission resource indication parameter is used for instructing the first access network device to determine a fourth physical resource for sending positioning data.

13. The positioning method according to claim 12, wherein the determining positioning assistance information in a case that the positioning assistance information comprises the positioning data transmission resource indication parameter comprises:
acquiring a sending parameter of positioning data for positioning the terminal device, wherein the sending parameter comprises one or more of a data size and a sending cycle of the positioning data; and
determining the positioning data transmission resource indication parameter according to the sending parameter.

14. (canceled)

15. A positioning method, performed by a first access network device, the positioning method comprising:
receiving positioning assistance information sent by a positioning device; and
determining a target positioning resource according to the positioning assistance information, wherein the target positioning resource is used for positioning a terminal device.

16. (canceled)

17. The positioning method according to claim 15, wherein the positioning assistance information is information determined by the positioning device according to a target parameter, the target parameter is a parameter sent by the terminal device or a second access network device to the positioning device, and the target parameter comprises one or more of a terminal type parameter and a discontinuous reception (DRX) parameter of the terminal device.

18. The positioning method according to claim 15, wherein the determining a target positioning resource according to the positioning assistance information comprises at least one of the following:
acquiring the discontinuous reception (DRX) parameter of the terminal device in a case that the positioning assistance information comprises a first PRS resource indication parameter, and determining, according to the DRX parameter, a first physical resource used for sending a PRS, wherein a sending time slot corresponding to the first physical resource is within a DRX on duration of the terminal device, the first PRS resource indication parameter is used for instructing the first access network device to determine, according to the discontinuous reception (DRX) parameter of the terminal device, a first physical resource used for sending a PRS;
determining a PRS configuration parameter corresponding to the terminal device according to a second PRS resource indication parameter in a case that the positioning assistance information comprises the second PRS resource indication parameter, determining, according to the PRS configuration parameter, a second physical resource used for sending the PRS, wherein the PRS configuration parameter is used for instructing that a sending time slot of the first access network device to send the PRS is within a DRX on duration of the terminal device, the second PRS resource indication parameter is a parameter which is determined by the positioning device according to a discontinuous reception (DRX) parameter of the terminal device and used for instructing the first access network device to determine a second physical resource used for sending a PRS; or
determining a target positioning resource for performing low-power-consumption positioning on the terminal device in a case that the positioning assistance information comprises a low-power-consumption indication parameter, wherein the low-power-consumption indication parameter is used for instructing the first access network device to perform low-power-consumption positioning on the terminal device.

19-20. (canceled)

21. The positioning method according to claim 15, further comprising:
sending a target parameter to the positioning device, wherein the target parameter comprises one or more of a terminal type parameter and a discontinuous reception (DRX) parameter of the terminal device.

22. The positioning method according to claim 15, wherein the receiving positioning assistance information sent by a positioning device comprises:
receiving, through one or more of a transmitting and receiving point (TRP) information request message and a PRS configuration request message, the positioning assistance information sent by a positioning device.

23. The positioning method according to claim 15, wherein the determining a target positioning source according to the positioning assistance information comprises at least one of the following:
determining, according to a physical random access channel (PRACH) resource indication parameter, a third physical resource used by the terminal device to send a positioning preamble in a case that the positioning assistance information comprises the PRACH resource indication parameter, wherein the third physical resource is used for receiving the positioning preamble sent by the terminal device, so that the terminal device is positioned, the PRACH resource indication parameter comprises one or more of a random access RACH occasion and a random access RACH permeable; or
determining, according to a positioning data transmission resource indication parameter, a fourth physical resource for sending positioning data to the terminal device in a case that the positioning assistance information comprises the positioning data transmission resource indication parameter, wherein the positioning data transmission resource indication parameter comprises one or more of a data size and a sending cycle of the positioning data.

24. (canceled)

25. The positioning method according to claim 23, further comprising:
sending a PRACH parameter to the positioning device, wherein the PRACH parameter is used for characterizing a PRACH resource used by the terminal device to send the positioning preamble.

26. The positioning method according to claim 23, wherein the receiving positioning assistance information sent by the positioning device comprises at least one of the following:
receiving, through a positioning measurement request message, the PRACH resource indication parameter sent by the positioning device; or
receiving, through a positioning information request message, the positioning assistance information sent by the positioning device.

27-31. (canceled)

32. A positioning apparatus, comprising:
one or more processors; and
a memory configured to store processor-executable instructions, wherein
the one or more processors are collectively configured to execute the processor-executable instructions in the memory, so as to cause the positioning apparatus to perform:
determining positioning assistance information; and
sending the positioning assistance information to a first access network device, wherein the positioning assistance information is used for instructing the first access network device to determine a target positioning resource according to the positioning assistance information, and position a terminal device according to the target positioning resource.

33. A non-transitory computer-readable storage medium storing computer program instructions thereon, wherein when the computer program instructions are executed by one or more processors, the positioning method according to claim 1 is implemented.

34. A chip, comprising one or more processors and an interface, wherein the one or more processors are collectively configured to read instructions to perform the positioning method according to claim 1.
